(19) United States
(12) Patent Application Publication
(10) Pub. No.: US 2005/0014526 A1
(43) Pub. Date: Jan. 20, 2005

(54) METHOD FOR IDENTIFYING A DETACHABLE COVER OF A PORTABLE COMMUNICATIONS DEVICE

(76) Inventor: Long-Jyh Pan, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,363

(22) Filed: Jul. 15, 2003

(51) Int. Cl. H04Q 7/20

(52) U.S. Cl. 455/550.1; 455/575.3

(57) ABSTRACT

A portable communications device includes a transceiver module and a cover detachably installed on the transceiver module. The cover contains magnetic media disposed on the cover, the magnetic media emitting a magnetic flux for identifying the cover. The transceiver module includes a magnetic sensor for measuring the magnetic flux emitted by the magnetic media and generating a corresponding output signal and a control circuit for receiving the output signal from the magnetic sensor and determining an identification of the cover based on the received output signal.

### BACKGROUND OF INVENTION

1. Field of the Invention

The present invention relates to a portable communications device, and more specifically, to a method for identifying a detachable cover of a portable communications device and adjusting a configuration of the device according to the identified cover.

2. Description of the Prior Art

Covers for portable communications devices, such as mobile phones, are crucial to the overall design of the portable communications devices. Furthermore, since consumers prefer to change the appearance of their mobile phones, it is now common to find mobile phones with swappable covers. For example, the Motorola® C330 series of mobile phones has three swappable covers with different shapes and textures that are used to cover the circuitry (such as the transceiver module) of the mobile phone. With this setup, users can easily and freely change the cover of the mobile phone without concern for the internal hardware or software of the mobile phone.

Please refer to FIG. 1 and FIG. 2. FIG. 1 is a perspective diagram of a portable communications device 10 according to the prior art. FIG. 2 is a perspective diagram of a front cover 20A and a rear cover 20B of the portable communications device 10. FIG. 1 shows the front cover 20A assembled with the rear cover 20B whereas FIG. 2 shows the front cover 20A and the rear cover 20B separately. For convenience, the front cover 20A and the rear cover 20B will collectively be referred to as a cover 20. The front cover 20A contains a transparent lens 22 for allowing a display screen to be seen through the lens 22. In addition, the front cover 20A contains a plurality of input keys 24 for inputting signals to the portable communications device 10.

Please refer to FIG. 3. FIG. 3 is a perspective diagram of a transceiver module 40 of the portable communications device 10. The front cover 20A and the rear cover 20B can be respectively installed on front and rear sides of the transceiver module 40, thereby enclosing the transceiver module 40 between the front cover 20A and the rear cover 20B. The transceiver module 40 contains a display 42 such as an LCD display and a plurality of key sensors 44 for receiving input from the plurality of input keys 24.

Covers 20 now come with a variety of different designs, and the design of the cover 20 may be a part of the theme of the phone. For example, as part of a sports theme, a surface of the cover 20 may have pictures of sports equipment on it. When a user swaps the cover of the portable communications device 10, the user may also wish to change the Man-Machine Interface (MMI) attributes of the portable communications device 10 to match the theme of the new cover 20. Unfortunately, the user will has to manually change the MMI attributes of the portable communications device 10 after swapping the cover 20 because the transceiver module 40 cannot automatically detect the identification of the cover 20.

### SUMMARY OF INVENTION

It is therefore a primary objective of the claimed invention to provide a portable communications device that can detect the identification of a cover in order to solve the above-mentioned problems.

According to the claimed invention, a portable communications device includes a transceiver module and a cover detachably installed on the transceiver module. The cover contains magnetic media disposed on the cover, the magnetic media emitting a magnetic flux for identifying the cover. The transceiver module includes a magnetic sensor for measuring the magnetic flux emitted by the magnetic media and generating a corresponding output signal and a control circuit for receiving the output signal from the magnetic sensor and determining an identification of the cover based on the received output signal.

It is an advantage of the claimed invention that the portable communications device is able to detect the identification of the cover and automatically configure the MMI attributes of the portable communications device for each cover used.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a perspective diagram of a portable communications device according to the prior art.

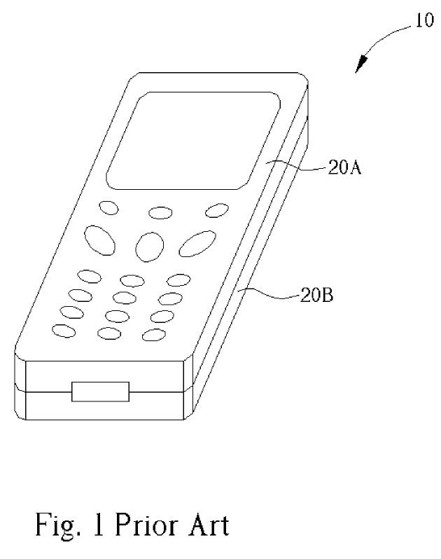

FIG. 2 is a perspective diagram of a front cover and a rear cover of the portable communications device.

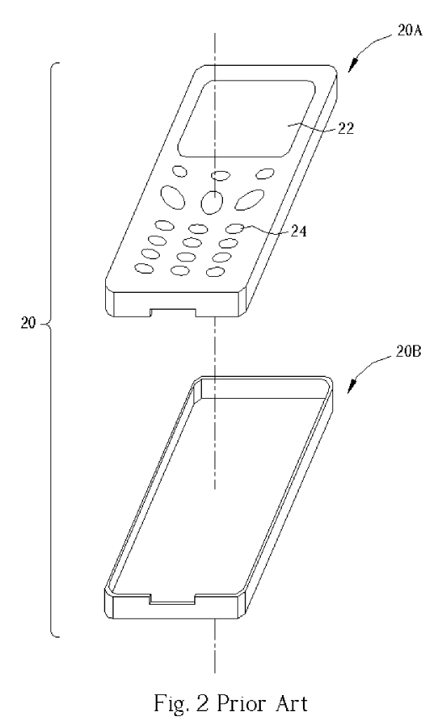

FIG. 3 is a perspective diagram of a transceiver module of the portable communications device.

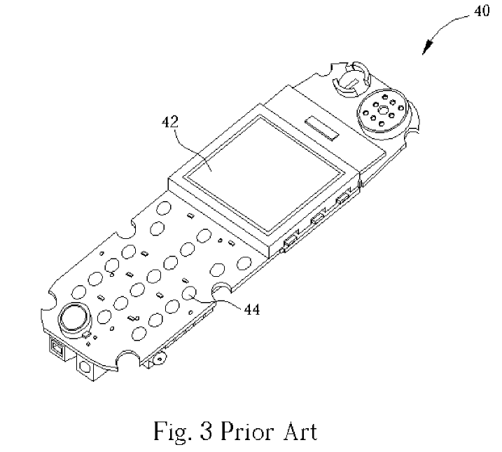

FIG. 4 is a diagram of a portable communications device according to the present invention.

FIG. 5 is a graph showing a relationship between measured magnetic flux and a corresponding output voltage produced by the magnetic sensor.

FIG. 6 is a functional block diagram of the portable communications device according to the present invention.

FIG. 7 is a flowchart illustrating the present invention method of identifying the cover and updating MMI attributes of the portable communications device according to the identity of the cover.

### DETAILED DESCRIPTION

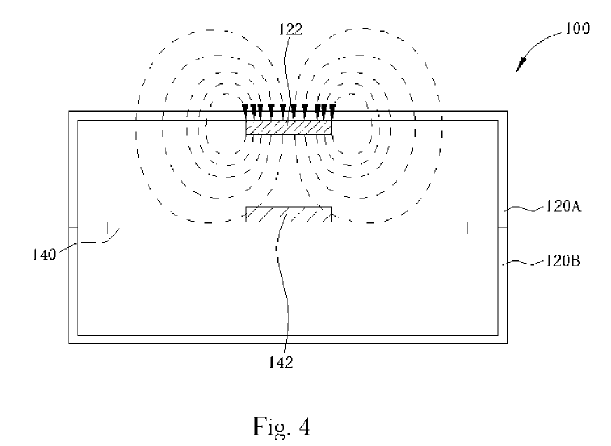

Please refer to FIG. 4. FIG. 4 is a diagram of a portable communications device 100 according to the present invention. Like the prior art portable communications device 10, the present invention portable communications device 100 contains a transceiver module 140 enclosed between a front cover 120A and a rear cover 120B. For convenience, the front cover 120A and the rear cover 120B will collectively be referred to as a cover 120. The portable communications device 100 contains magnetic media 122 installed on the cover 120 for providing unique identification for each cover 120. A magnetic sensor 142 is disposed on the transceiver module 140 for sensing the magnetic flux produced by the magnetic media 122 and generating a corresponding output voltage signal.

In the preferred embodiment shown in FIG. 4, the magnetic media 122 is a magnet, and the magnetic media 122 is disposed on an inside surface of the front cover 120A. Magnetic powder can also be used instead of a magnet, as is well known by those skilled in the art. The magnetic sensor 142 is preferably formed on a printed circuit board (PCB) within the transceiver module 140. For best results, the magnetic sensor 142 should be as close to the magnetic media 122 as possible for accurately measuring the magnetic flux produced by the magnetic media 122. Please note that the locations of the magnetic media 122 and the magnetic sensor 142 shown in FIG. 4 are merely used as examples. The magnetic media 122 can be disposed anywhere on the cover 120 of the portable communications device 100, and the magnetic sensor 142 can be disposed anywhere on the transceiver module 140.

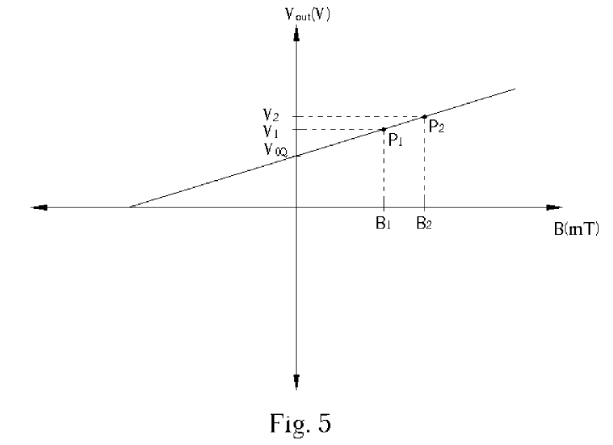

Please refer to FIG. 5. FIG. 5 is a graph showing a relationship between measured magnetic flux B (measured in mT) and a corresponding output voltage Vₒᵤₜ (measured in V) produced by the magnetic sensor 142. The magnetic sensor 142 is preferably a linear Hall effect sensor, and the output voltage Vₒᵤₜ is an analog output voltage that is proportional to the magnetic flux B measured perpendicular through the magnetic sensor 142. The slope of the line shown in FIG. 5 is dependent on the sensitivity of the magnetic nsensor 142. Moreover, a quiescent voltage V_{OQ} is a voltage level that the magnetic sensor 142 outputs when no magnetic field is present (i.e. B=0 mT).

In order for the magnetic media 122 to be used as an identification of the cover 120, each different type of cover 120 must contain magnetic media 122 with a unique magnetic flux value. For example, suppose that point P1 in FIG. 5 represents a first cover placed on the transceiver module 140. A measured magnetic flux value is denoted by B1 and the corresponding analog output voltage is denoted by V1. Point P2 represents a second cover placed on the transceiver module 140 instead of the first cover. Point P2 has a magnetic flux value of B2 and a corresponding analog output voltage of V2. Because each cover 120 used in the present invention produces different output voltages in the magnetic sensor 142, the transceiver module 140 is able to identify each cover 120 by simply measuring the magnetic flux produced by the magnetic media 122 of the cover 120. Once the cover 120 has been identified by the transceiver module 140, the transceiver module 140 can customize settings of the portable communications device 100 according to the identification of the cover 120.

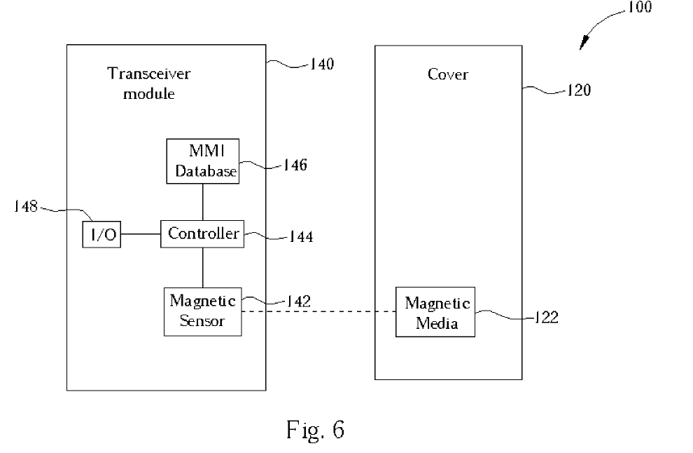

Please refer to FIG. 6. FIG. 6 is a functional block diagram of the portable communications device 100 according to the present invention. After the magnetic sensor 142 measures the magnetic flux of the magnetic media 122 formed on the cover 120, the magnetic sensor 142 transmits the analog output voltage to a controller 144 of the transceiver module 140. The controller 144 is used for controlling operations of the transceiver module 140. After receiving the analog output voltage from the magnetic sensor 142, the controller 144 determines the identity of the cover 120 by comparing the analog output voltage value to a list of voltage values for known covers 120. The controller 144 then searches a Man-Machine Interface (MMI) database 146 for MMI attributes corresponding to the identified cover 120. The controller 144 can then configure input and output (I/O) devices 148 to match the settings specified in the MMI database 146. For example, the MMI database 146 can customize audio and visual settings of the portable communications device 100 in a theme corresponding to each cover 120.

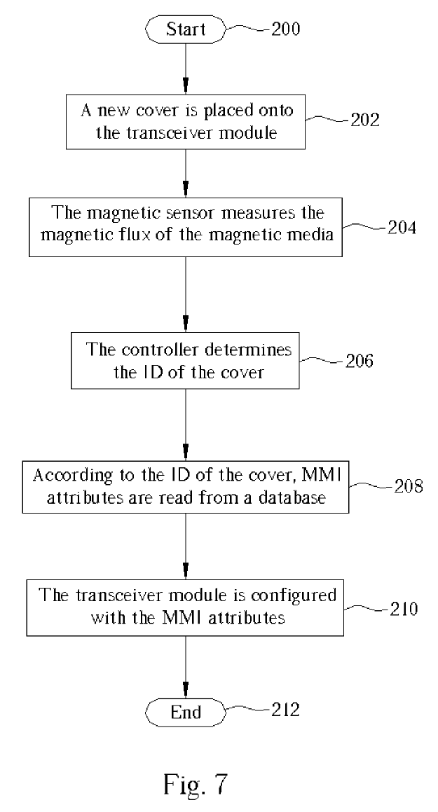

Please refer to FIG. 7. FIG. 7 is a flowchart illustrating the present invention method of identifying the cover 120 and updating MMI attributes of the portable communications device 100 according to the identity of the cover 120. Steps contained in the flowchart will be explained below.

Step 200: Start;

Step 202: A new cover 120 is placed onto the transceiver module 140 of the portable communications device 100;

Step 204: The magnetic sensor 142 measures the magnetic flux of the magnetic media 122;

Step 206: The controller 144 determines the identification of the cover 120 based on the analog output voltage outputted from the magnetic sensor 142;

Step 208: According to the identification of the cover 120, the controller 144 searches the MMI database 146 for MMI attributes corresponding to the identified cover 120;

Step 210: The transceiver module 140 is configured with the MMI attributes read from the MMI database 146; and

Step 212: End.

The present invention is well suited for any portable communications device, such as a mobile phone, which has a detachable cover that can be swapped with other covers. In addition to MMI attributes, any attribute that can be customized according to the identification of the cover falls within the scope of the present invention.

In contrast to the prior art portable communications device 10 in which users had to manually update MMI attributes after swapping the cover 20 of the portable communications device 10, the present invention portable communications device 100 is capable of identifying the cover 120 and updating the MMI attributes automatically. Users can freely swap the covers of portable communications devices and completely update the theme of the portable communications devices without configuring additional settings.

Those skilled in the art will readily observe that numerous modifications and alterations of the device may be made while retaining the teachings of the invention. Accordingly, the above disclosure should be construed as limited only by the metes and bounds of the appended claims.

1. A portable communications device comprising:
a cover comprising magnetic media disposed on the cover, the magnetic media emitting a magnetic flux for identifying the cover; and
a transceiver module, the cover being detachably installed on the transceiver module, the transceiver module comprising:
a magnetic sensor for measuring the magnetic flux emitted by the magnetic media and generating a corresponding output signal; and
a control circuit for receiving the output signal from the magnetic sensor and determining an identification of the cover based on the received output signal.

2. The portable communications device of claim 1 further comprising a database stored in a memory for storing Man-Machine Interface (MMI) attributes corresponding to the identification of the cover.

3. The portable communications device of claim 1 wherein the cover comprises a front cover and a rear cover, and the magnetic media is disposed on an inner side of the front cover.

4. The portable communications device of claim 1 wherein the magnetic sensor is disposed on a printed circuit board (PCB) of the transceiver module.

5. The portable communications device of claim 1 wherein the output signal generated by the magnetic sensor is an analog output voltage.

6. The portable communications device of claim 5 wherein the magnetic sensor is a linear Hall effect sensor and the analog output voltage is directly proportional to the measured magnetic flux.

7. The portable communications device of claim 1 wherein the magnetic media is a magnet.

8. The portable communications device of claim 1 wherein the magnetic media is magnetic powder.

9. The portable communications device of claim 1 being a mobile phone.

10. A method of identifying a detachable cover of a portable communications device, the method comprising:
providing magnetic media disposed on the cover, the magnetic media emitting a magnetic flux for identifying the cover;
measuring the magnetic flux emitted by the magnetic media and generating a corresponding output signal with a magnetic sensor; and
determining an identification of the cover based on the output signal.

11. The method of claim 10 further comprising searching a database stored in a memory of the portable communications device for Man-Machine Interface (MMI) attributes corresponding to the identification of the cover and loading the MMI attributes into the portable communications device.

12. The method of claim 10 wherein the cover comprises a front cover and a rear cover, and the magnetic media is disposed on an inner side of the front cover.

13. The method of claim 10 further comprising disposing the magnetic sensor on a printed circuit board (PCB) of the transceiver module.

14. The method of claim 10 wherein the output signal generated by the magnetic sensor is an analog output voltage.

15. The method of claim 14 wherein the magnetic sensor is a linear Hall effect sensor and the analog output voltage is directly proportional to the measured magnetic flux.

16. The method of claim 10 wherein the magnetic media is a magnet.

17. The method of claim 10 wherein the magnetic media is magnetic powder.

18. The method of claim 10 wherein the portable communications device is a mobile phone.
